(19) United States
(12) Patent Application Publication
(10) Pub. No.: US 2016/0187274 A1
(43) Pub. Date: Jun. 30, 2016

(54) DYNAMIC CHEMICAL SENSORS

(71) Applicant: EMPIRE TECHNOLOGY DEVELOPMENT LLC, Wilmington, DE (US)

(72) Inventor: Aya SEIKE, Tokyo (JP)

(73) Assignee: EMPIRE TECHNOLOGY DEVELOPMENT LLC, Wilmington, DE (US)

(21) Appl. No.: 14/909,033

(22) PCT Filed: Jul. 31, 2013
(86) PCT No.: PCT/US2013/052878

§ 371 Date: Jan. 29, 2016

(51) Int. Cl. G01N 27/02; B01L 3/00

(52) U.S. Cl. CPC G01N 27/021; B01L 3/502; B01L 2300/165; B01L 2300/18; B01L 2300/0627

(57) ABSTRACT

Provided herein are embodiments relating to chemical sensors. The sensors include one or more molecules that can transition between the cis and trans configurations thereby altering the degree of hydrophobicity of the system and providing for a sensor whose sensitivity and/or selectivity in regard to hydrophobicity can be altered as desired.

### BACKGROUND

While there are a wide variety of chemical sensors, in some systems, molecular probes for chemical sensors selectively bind to target molecules via a specific complementary receptor or binding partner, which can be immobilized on a surface or film. In general, while the resulting film can be used for the detection of the complementary target molecule, a different film is generally used (containing different receptors or binding partners) when a different target molecule is to be tested for. Thus, in some situations, multiple organic films (including, for example different DNAs with probes) are used for sensing multiple analytes in a sample and/or different aspects of the analytes.

### SUMMARY

In some embodiments, a sensor is provided. The sensor can include at least one channel and at least one azobenzene compound coupled to the channel.

In some embodiments, a method of making a sensor is provided. The method can include contacting an azobenzene compound with a surface of a channel.

In some embodiments, a method of sensing an analyte is provided. The method can include providing a sensor including a channel and an azobenzene compound coupled to the channel, contacting a sample suspected of containing an analyte with the azobenzene compound, applying a voltage to the channel that is effective to obtain a current through the channel, and measuring the current through the channel while applying the voltage.

In some embodiments, a kit is provided. The kit can include a sensor configured to detect an analyte. The sensor can include a source region, a drain region, a channel configured to electrically couple the source region and the drain region, and a self-assembled monolayer disposed on the channel, the self-assembled monolayer including an azobenzene compound coupled to the self-assembled monolayer. The azobenzene compound can be represented by Formula (I) or Formula (II):

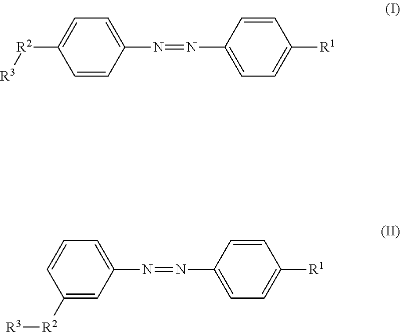

In some embodiments, R¹ is a hydrophobic moiety, R² is a spacer group, and R³ is a coupling moiety.

In some embodiments, a sensor chip is provided. The chip can include a flow cell path configured to permit a fluid to flow across a surface, a source region, a drain region, a channel in electrical communication with the source region and the drain region. The channel can be positioned within the flow cell path and a plurality of azobenzene compounds are covalently attached along a length of the channel. The azobenzene compounds can be represented by Formula (I) or Formula (II):

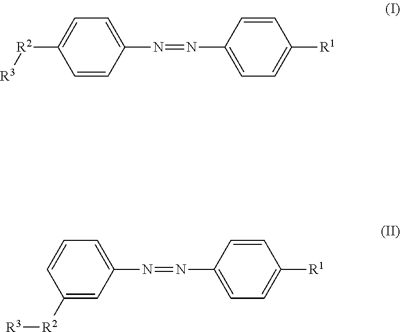

In some embodiments, R¹ is a hydrophobic moiety, R² is a spacer group, and R³ is a coupling moiety.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic drawing of some embodiments of a dynamic sensor that includes an azobenzene group.

FIGS. 2A and 2B are schematic drawings of some embodiments of a dynamic sensor that includes azobenzene groups in trans or cis configurations.

FIG. 3A is a schematic drawing of some embodiments of a dynamic sensor that includes an azobenzene group in a trans configuration to provide a hydrophobic surface.

FIG. 3B is a schematic drawing of some embodiments of a dynamic sensor that includes an azobenzene group in a cis configuration to provide a hydrophilic surface.

FIG. 4A is a schematic drawing of some embodiments of how to attach the azobenzene compound to a substrate.

FIG. 4B is a schematic drawing of some embodiments of a dynamic sensor demonstrating steric hindrance if the azobenzene compounds are placed closely together.

FIGS. 5A-5C are schematic drawings of some embodiments of how to assemble the azobenzene compounds onto a substrate so as to reduce steric hindrance.

FIG. 6 is a schematic drawing of some embodiments of options for attaching the spacer to the azobenzene group.

FIG. 7 is set of graphs depicting relationships between current, voltage, and conductance over time as additional molecules attached to the chemical probe.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Some embodiments provided herein relate to dynamic chemical sensors and/or methods of detecting various molecules. In some embodiments, the technology includes the use of molecules that can have their hydrophobicity controlled and/or altered. Furthermore, by changing the hydrophobicity of these molecules (for example, from hydrophobic to hydrophilic), various analytes can be detected based on the analytes' sensitivity to hydrophobic environments, hydrophilic environments, and/or changes between hydrophobic and hydrophilic environments. Thus, the device and methods can allow for a dynamic component in regard to hydrophobicity in the detection of an analyte or for one to use the same sensor for the selective detection of both hydrophobic analytes and hydrophilic analytes. In some embodiments, a device or method can be used to assay a sample for analytes and identify the presence or absence of different analytes by these hydrophobicity characteristics (or changes thereto). In some embodiments, the molecule that can be used in the detection arrangement includes an azobenzene moiety, which can be manipulated between properties (for example, hydrophobic to hydrophilic or vice versa), by changes in (including the application of) radiation and/or temperature. These and additional embodiments are discussed in more detail below.

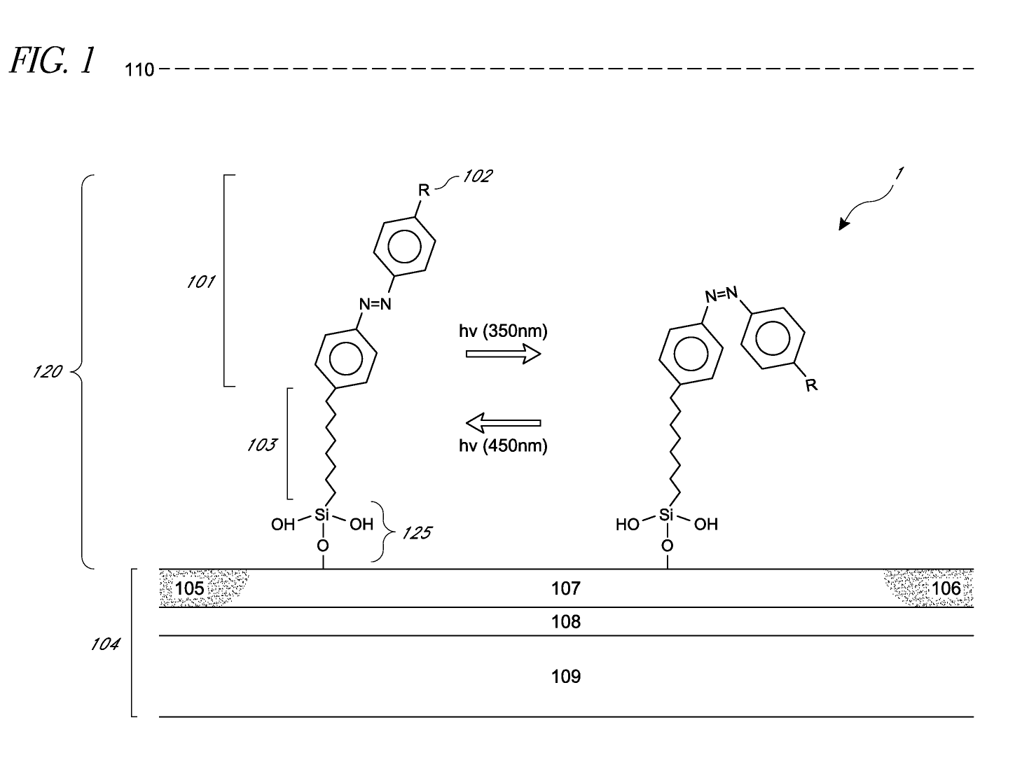

As depicted in FIG. 1, in some embodiments, a sensor 1 is provided. The sensor can include at least one channel 107 and at least one azobenzene compound 120. The azobenzene compound 120 can include a coupling moiety 125 attached to a spacer moiety 103, attached to an azobenzene moiety 101, such as azobenzene, that is then attached to a hydrophobic moiety 102. The azobenzene compound 120 is attached to a substrate 109 either directly or indirectly. In some embodiments, the azobenzene compound 120 is attached to a channel 107, that is then associated with the substrate 109 (for example, via an insulator 108). In some embodiments, the source 105, channel 107, drain 106, insulator 108, and substrate 109 are configured to form a transistor 104, upon which the azobenzene compound can be placed and binding to the azobenzene compound can be monitored. In some embodiments, the sensor 1 further includes a source region 105 and a drain region 106. The channel 107 can be configured to electrically couple the source region 105 and the drain region 106.

In some embodiments, the sensor 1 further includes a self-assembled monolayer on the channel 107. The self-assembled monolayer can include one or more of the azobenzene compounds. In some embodiments, the self-assembled monolayer is made of numerous azobenzene compounds 120. In some embodiments, the self-assembled monolayer can include any hydrophobic material (for example, hydrophobic material in addition to the azobenzene compound). In some embodiments, an additional hydrophobic aspect of the azobenzene compound can be provided by a spacer moiety 103 and/or the coupling moiety 125, allowing the spacers and/or linkers to associate with one another to for the self-assembled monolayer.

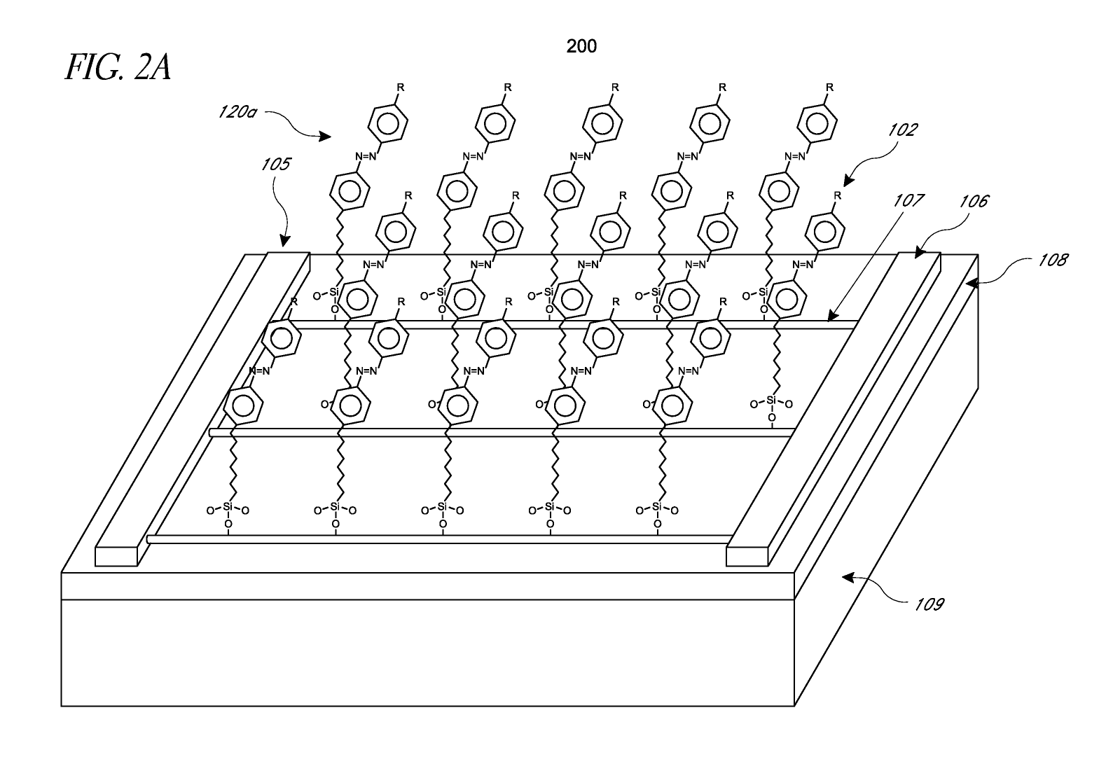

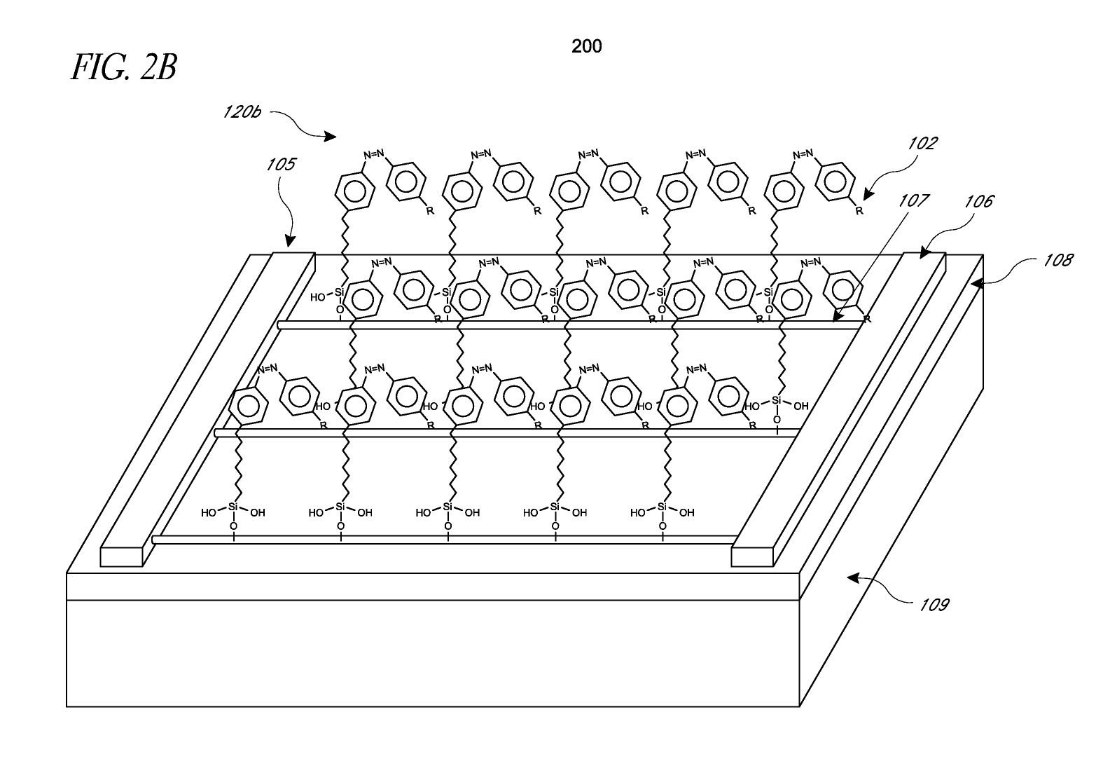

FIGS. 2A and 2B depict additional embodiments of the sensor device as shown in FIG. 1. As shown in FIG. 2A, when the azobenzene compound is in the trans configuration 120a (FIG. 2A), the hydrophobic moiety 102 is relatively exposed to the bulk solution 200. However, as shown in FIG. 2B, when the azobenzene compound is in the cis configuration 120b, the hydrophobic moiety 102 is relatively hidden from the bulk solution of the sample. As shown in FIGS. 2A and 2B, while the azobenzene compounds can be positioned along the channels 107, the azobenzene compounds can also be elsewhere (for example, between the channels 107). Thus, the azobenzene compounds need not be exclusively placed along the channels. However, as will be appreciated by one of skill in the art, where detection is achieved by the azobenzene compound's association with the channel 107 (via changes in conductance), binding for those molecules not associated with the channel may not result in changes in conductance. Furthermore, as explained in more detail below, in some embodiments, excessive amounts of molecules in the layer can result in steric hindrance, which may not be desirable in some embodiments.

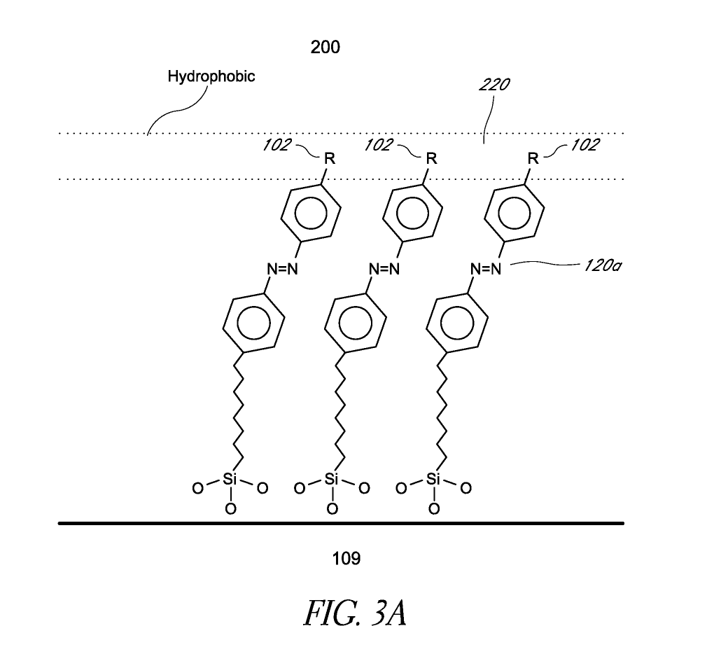

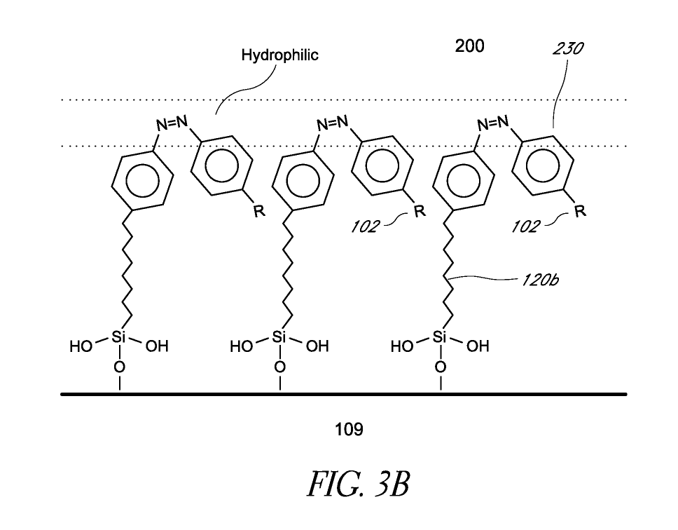

In some embodiments, the azobenzene compound 120 further includes a hydrophobic moiety 102, located on the opposite end of the azobenzene compound (from the spacer 103 and linker 125). As shown in FIG. 3A, when the azobenzene compound is in the trans configuration 120a, the outer hydrophobic moieties 102 are exposed to the bulk of the sampling volume 200, thereby providing a hydrophobic area 220. However, as shown in FIG. 3B, when the azobenzene compounds are in the cis configuration 120b, the hydrophobic moieties 102 are biased back towards the substrate 109, and away from the bulk volume 200, such that the nitrogen double bond of the azobenzene compound is biased to exposure to the bulk volume 200, providing a relatively hydrophilic area 230. Thus, a sensor device as provided herein can provide a dynamic change in regard to its own hydrophobicity, which can in turn be used as a selection criteria when detecting analytes. In some embodiments, by having the capability of changing the hydrophobicity, molecules in a sample can be assayed under both hydrophobic and hydrophilic conditions of the system, to see if any binding occurs under either (or both) of the environments.

In some embodiments, the channel 107 is configured as part of a nanodot transistor, nanowaire transistor, carbon nanotube transistor and/or a field effect transistor (such as a FinFET transistor). In some embodiments, the transistor can have a back gate configuration and the substrate 109 can serve as the back gate.

In some embodiments, the channel 107 has a width of less than about 15 nm (for example, less than 10 nm). In some embodiments, the channel's width can be varied as desired and can be wider then about 15 nm. In some embodiments, the channel 107 can be made of any conductive material that allows for electrical communication between two points (the source 105 and the drain 106), as well as allowing for changes in electrical potential and/or conductance occurring due to binding of analytes to the azobenzene compounds to be communicated along the channel 107.

As noted above, in some embodiments, the sensor 1 further includes an insulating layer 108. In some embodiments, the channel 107 can be disposed on the insulating layer 108. In some embodiments, where the channel itself includes an insulating layer, the insulating layer 108 need not be present. In some embodiments, the insulating layer can be made of any non and/or low conducting material. As noted above, in some embodiments, the insulator can be any effective insulator for use in a field effect transistor.

In some embodiments, the sensor further includes a substrate 109. The insulating layer 108 can be disposed between the substrate 109 and the channel 107. The substrate can be made of any material that can support the azobenzene compound. In some embodiments, the substrate is made of glass, plastic, metal, and so on. In some embodiments, any substrate effective for use in a field effect transistor can be used.

A variety of azobenzene compounds can be used for the present sensors and methods. In some embodiments, any azobenzene compound that can undergo a structural change can be employed. In some embodiments, the compound can undergo this structural change in response to an external stimulus, such as heat, radiation, and/or light. In some embodiments, this change is reversible, so as to allow one to transition between different configurations as desired. In some embodiments, the conformational change that the azobenzene compound undergoes is a transition from cis to trans. Thus, in some embodiments, any azobenzene compound can be employed, as long as it can reversibly undergo a cis to trans and/or trans to cis conformational change in response to heat, light, and/or radiation. In some embodiments, the azobenzene compound can include a moiety to assist with linking the azobenzene compound to a substrate (coupling moiety 125), a moiety to assist in spacing the azobenzene compounds apart and/or from the substrate (a spacer moiety 103), and/or a hydrophobic moiety 102. In some embodiments, the hydrophobic moiety 102 can be used to add additional specificity to the detection system. In some embodiments, the hydrophobic moiety 102 can have selective binding properties of its own (for example, selectively bind to an analyte). In other embodiments, the hydrophobic moiety 102 can be any molecule that is hydrophobic, and thus, serves to bind any hydrophobic analyte or part thereof.

In some embodiments, the azobenzene compound is represented by Formula (I) or Formula (II):

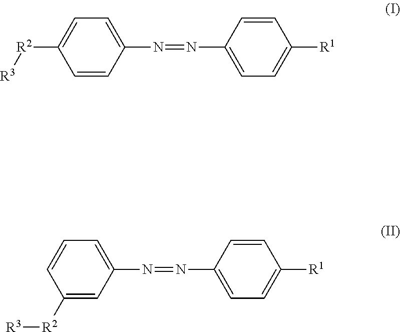

wherein R¹ is a hydrophobic moiety, R² is a spacer moiety, and R³ is a coupling moiety.

In some embodiments, the coupling moiety 125 (R³) includes a silane, a thiol, or a phosphonate group. In some embodiments, any coupling moiety can be used, and in part, it can be selected based upon a surface to which the azobenzene compound is to be coupled to. In some embodiments, the coupling moiety (R³) is —SiX₃, and X is a hydrolyzable group. In some embodiments, the hydrolyzable group is hydrogen, C₁₋₆-alkoxy, acyloxy, amine, bromine, or chlorine. In some embodiments, the silane is an organic silane. In some embodiments, the silane includes SiRₙX₄₋ₙ, and at least one of the functional group is substituted by an organic group. An organic silane group can react with a hydroxyl group from the oxide substrate surface, and can have a covalent compound with the substrate and can be immobilized. The oxide used can include, for example, silicon oxide, Titanium oxide, ITO, mica, Aluminum oxide, glass, Tin oxide, and/or Germanium oxide.

In some embodiments, the spacer moiety (R²) is a C₁₋₃₀-alkylene. In some embodiments, any spacer moiety can be used. In some embodiments, the spacer moiety (R²) is hydrophobic, to allow for greater ease of self assembly of the azobenzene compound on the surface of the substrate. In some embodiments, the number of carbons in the spacer moiety (for example, CH₂ in a linear chain) can be an even number. In some embodiments, the number of carbons in the spacer moiety (for example, CH₂ in a linear chain) can be an odd number. In some embodiments, the spacer moiety (R²) 103 can be any length of (CH₂)ₙ, where n can be any integer. In some embodiments, the integer n can be an even number when the spacer is attached at the para (4^{th}) position of the second outermost phenyl in the azobenzene from the N═N. In some embodiments, the integer n can be an odd number when the spacer is attached at the meta (3^{rd}) position of the second outermost phenyl in the azobenzene from N═N. These arrangements bias the location of the hydrophobic moiety 102 to the outermost surface (for example, close to the bulk solution) when in the trans configuration and bias the N═N to the bulk solution when the azobenzene moiety is in the cis configuration. When an analyte is a protein, the length of the spacer is sufficient to hold the protein both in cis and trans position. In some embodiments, the spacer can be any length, as long as it maintains adequate mechanical strength.

In some embodiments, the coupling moiety and/or spacer moiety together allow for the azobenzene compound to be positioned at some distance from a surface and/or other azobenzene compounds. This can be useful so as to reduce steric constraints that may occur if the azobenzene compound is positioned too closely to other structures (such as a surface of the channel 107 or substrate 109, or other azobenzene compound molecules). In some embodiments, this spacing ability can be achieved via the size and/or properties of the spacer moiety 103. In some embodiments, this spacing ability can be achieved via the size and/or properties of the coupling moiety 125. In some embodiments, this spacing ability can be achieved via the size and/or properties of both the coupling moiety 125 and the spacer moiety 103. In some embodiments, the azobenzene moiety is positioned far enough from a surface (such as a surface of a channel 107 or a surface of the substrate 109) so that the trans to cis and/or cis to trans conformational change can occur. In some embodiments, the azobenzene moiety is positioned far enough from a surface (such as a surface of a channel 107 or a surface of the substrate 109) so that the trans to cis and/or cis to trans conformational change can occur with minimal steric interference from the surfaces.

In some embodiments, the azobenzene compound includes a hydrophobic moiety 102. In some embodiments, the hydrophobic moiety (R¹) can be any moiety that is hydrophobic. In some embodiments, the hydrophobic moiety is configured appropriately so that the transition from trans to cis of the azobenzene compound can effectively change the exposure of the hydrophobic moiety to the bulk solution. For example, in some embodiments, the hydrophobic moiety is not so large such that the trans to cis transition fails to move the hydrophobic moiety away from the bulk solution. In some embodiments, the hydrophobic moiety is adequately confined on the end of the azobenzene compound so that the trans to cis conformational change is effective, for example, the conformational change biases the presence of the hydrophobic moiety away from the bulk solution. In some embodiments, the hydrophobic moiety 102 (R¹) can include at least one of an alkyl, a haloalkyl, a fatty acid, a halogen (—F, —Cl, —Br, −1) group, and so on.

In some embodiments, the azobenzene compound is represented by Formula (I) and the spacer group is a C₁₋₂₀-alkylene having an even number of carbon atoms. In some embodiments, the azobenzene compound is represented by Formula (II) and the spacer group is a C₁₋₂₀-alkylene having an odd number of carbon atoms. In some embodiments, the azobenzene compound is represented by the compound of Formula (III):

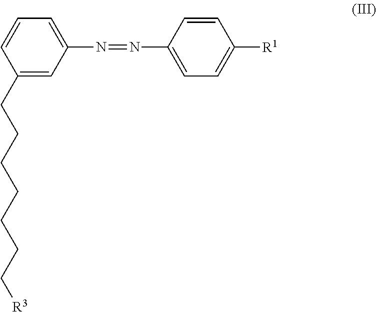

In some embodiments, R¹ is methyl, tert-butyl, trifluoromethyl, fluorine, chlorine, bromine, or iodide, and R³ is a silane coupling moiety.

In some embodiments, the azobenzene compound is represented by the compound of Formula (IV):

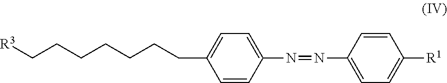

In some embodiments, R¹ is a hydrophobic molecule, a protein, a nucleic acid, methyl, tert-butyl, trifluoromethyl, fluorine, chlorine, bromine, or iodide, and R³ is a silane coupling moiety.

In some embodiments, the sensor further includes an optical filter 110 (FIG. 1) configured to selectively transmit radiation having a wavelength effective to photoisomerize the azobenzene compound. In some embodiments, the filter is configured to transmit wavelengths of about 350 nm. In some embodiments, the filter is configured to transmit wavelengths that correspond to UVA wavelengths. In some embodiments, the filter is configured to transmit wavelengths of about 315 nm to about 400 nm, for example, 320 nm, 330 nm, 340 nm, 350 nm, 360 nm, 370 nm, 380 nm, 390 nm or 400 nm, including any range between any two of the preceding values. In some embodiments, the filter is configured to transmit wavelengths of about 450 nm. In some embodiments, the filter is configured to transmit wavelengths that correspond to visible light wavelengths. In some embodiments, the filter is configured to transmit wavelengths of about 400 nm to about 500 nm, for example, 410 nm, 420 nm, 430 nm, 440 nm, 450 nm, 460 nm, 470 nm, 480 nm, 490 nm, or 500 nm, including any range between any two of the preceding values. In some embodiments, the device can include both filters, so that the wavelength of radiation that is transmitted to the azobenzene compounds can be changed. In some embodiments, the wavelength to transform from trans to cis is from 320-400 nm. In some embodiments, the wavelength to transform from trans to cis is from 300-450 nm. In some embodiments, the wavelength to transform from cis to trans is 400 nm to 500 nm. The specific wavelength can depend upon what is attached in the system.

In some embodiments, the sensor further includes a light source configured to emit radiation effective to photoisomerize the azobenzene compound from a cis isomer to a trans isomer, or from a trans isomer to a cis isomer. In some embodiments, the radiation effective to photoisomerize the azobenzene compound from a trans isomer to a cis isomer has a wavelength of about 350 nm. In some embodiments, the radiation effective to photoisomerize the azobenzene compound from a cis isomer to a trans isomer has a wavelength of about 450 nm. In some embodiments, the radiation has wavelengths that correspond to UVA wavelengths. In some embodiments, the radiation has wavelengths of about 315 nm to about 400 nm, for example, 320 nm, 330 nm, 340 nm, 350 nm, 360 nm, 370 nm, 380 nm, 390 nm or 400 nm, including any range between any two of the preceding values. In some embodiments, the radiation has wavelengths that correspond to visible light wavelengths. In some embodiments, the radiation has wavelengths of about 400 nm to about 500 nm, for example, 410 nm, 420 nm, 430 nm, 440 nm, 450 nm, 460 nm, 470 nm, 480 nm, 490 nm, or 500 nm, including any range between any two of the preceding values. In some embodiments, the wavelength to transform from trans to cis is from 320-400 nm. In some embodiments, the wavelength to transform from trans to cis is from 300-450 nm. In some embodiments, the wavelength to transform from cis to trans is 400 nm to 500 nm.

In some embodiments, the sensor further includes a heat source configured to emit heat effective to photoisomerize the azobenzene compound. In some embodiments, the cis isomer can be switched to the trans isomer by the application of heat (K_{B}T, where K_{B} is the Boltzman constant and T is the absolute temperature). In some embodiments, the cis arrangement will thermodynamically transform from cis to trans within 20 to 25 minutes at room temperature. In some embodiments, additional heat will result in faster thermal isomerization to convert from the cis form to the trans form faster (for example, 80 degrees Celsius for 1 to 3 minutes will convert from cis to trans).

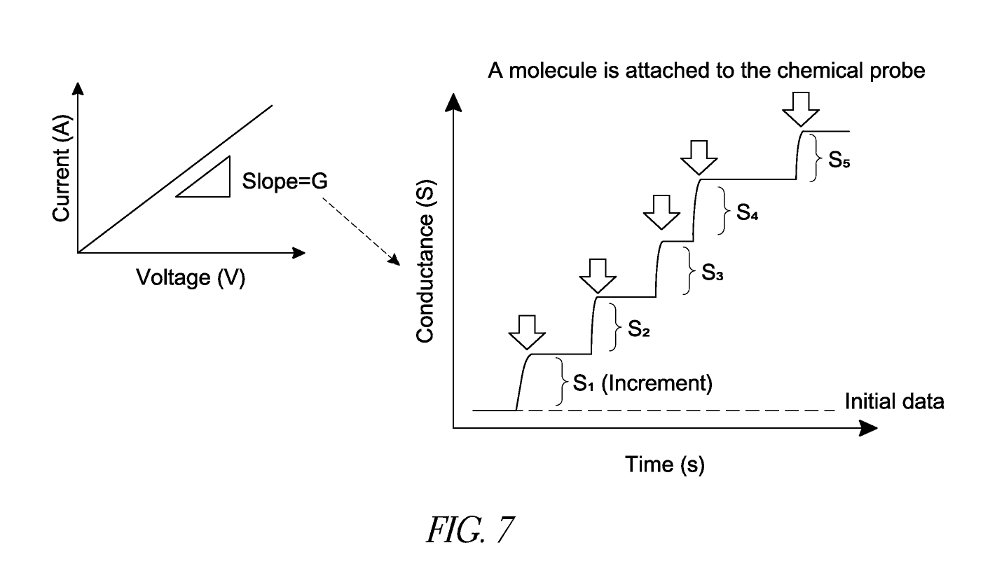

In some embodiments, a method of sensing an analyte is provided. The method can include providing any of the azobenzene compound sensors provided herein. In some embodiments, the sensor includes a channel and an azobenzene compound coupled to the channel. The method can further include contacting a sample suspected of containing an analyte with the azobenzene compound, applying a voltage to the channel that is effective to obtain a current through the channel, and measuring the current through the channel while applying the voltage. In some embodiments, an analyte's attraction to a N═N or a hydrophobic moiety 102 can be detected by evaluating the conductance of field effect transistor (FET). Changes in the current (or conductance, as shown in the stepwise increase in conductance in FIG. 7) can be correlated to association of molecules with the azobenzene compounds. Thus, the sensor allows for a method whereby changes in conductance can be correlated with association of molecules to the azobenzene compound (in either the cis or trans configuration). The present embodiments allow one to further assay binding characteristics of the analytes in the sample (and thus further characterize and thereby identify the analytes in the sample) by altering the hydrophobicity of the system by changing the conformation of the azobenzene compound from a trans (or cis) configuration to a cis (or trans) configuration.

In some embodiments, the field effect transistor can include nanowires, carbon nanotubes and/or other materials with less than 10 nm in diameter as the channel. In some embodiments, the transistor can be used to measure current that goes through the channel 107 at an applied voltage. Conductance G can then be calculated from the current I and voltage V measurement (G=I/V). In some embodiments, conductance is measured as a function of time and the change in conductance can be used for identifying the attracted analyte. As depicted in FIG. 7, an increase in conductance (shown as steps S1, S2, S3, S4, and S5) can be detected by measuring the slope of IV curve as a target analyte is attracted to the azobenzene compound. As more analyte is attracted, there is an increase in conductance.

In some embodiments, the method can be performed by running a sample over the azobenzene compound sensor when the azobenzene compound is in the trans configuration (and thus a relatively hydrophobic sensor surface is in place, for example, as shown in FIG. 3A), and detecting an amount of binding in this arrangement. In some embodiments, this arrangement can be ensured by exposing the sensor (and the azobenzene compounds in particular) to visible wavelengths of light (for example, 450 nm) to bias the azobenzene compounds into the trans configuration. Once a sample is analyzed with the trans arrangement sensor, one can then alter the hydrophobicity of the azobenzene compounds by transitioning them to the cis configuration and detecting an amount of binding in this arrangement. In some embodiments, this method allows one to characterize an analyte in a sample based upon the analyte's ability to bind under varying levels of hydrophobicity.

In some embodiments, rather than general changes in hydrophobicity, the azobenzene compound can include, as its hydrophobic moiety 102, a moiety to which an analyte will selectively bind. In such an arrangement, the method and system can be used to selectively expose (for example, in the trans configuration) or hide (for example, in the cis configuration) the hydrophobic moiety 102, thereby giving the user the option of reducing or allowing binding to the azobenzene compound as desired (without having to remove the sample or change sensors).

In some embodiments, the ability to generally change the hydrophobicity of a detection surface can also be combined with specific receptors or binding moieties. Thus, in some embodiments, additional binding molecules (separate from the azobenzene compound) can be included in the surface of the device. Such binding molecules (such as receptors, antibodies, ligands, and so on), can be associated with the channel, such that binding can be detected, but need not be linked to the azobenzene compound to undergo a conformational change. Rather, in such embodiments, one has an additional variable (further to the specific binding of, for example, a ligand binding to an immobilized receptor), in particular, the ability of the analyte to bind to the binding molecule when the environment of the binding molecule is either hydrophilic or hydrophobic. Thus, in some embodiments, the ability to transition between hydrophobic and hydrophilic allows one an additional variable by which a sample can further be analyzed.

In some embodiments, the method further includes contacting a different (for example a second) sample with the azobenzene compound, wherein the second sample is substantially free of the analyte, applying a second voltage to the channel that is effective to obtain a current through the channel, and measuring the current through the channel while applying the second voltage. Such a process can be used to establish a control or a baseline conductance for samples that are the same and/or similar to the sample to be tested for the analyte.

In some embodiments, the method can include contacting a sample (for example, a third sample) with the azobenzene compound. The sample can contain a pre-determined amount of the analyte. The method can further include applying a third voltage to the channel that is effective to obtain a current through the channel and measuring the current through the channel while applying the second voltage. Such a process can be used to establish a positive control for the presence of the sample. In some embodiments, a series of such samples, with increasing and known amounts of the analyte can be used so that appropriate response curves can be generated for a given level of analyte. Such information can be used to allow one to not only detect the presence of an analyte, but in some embodiments, a concentration as well.

In some embodiments, the sensor used in the method can include any of the arrangements provided herein, for example, the sensor can include the azobenzene compound represented by Formula (I) or Formula (II):

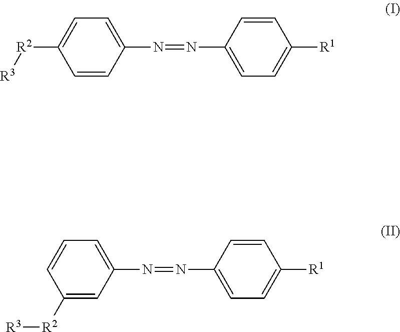

In some embodiments, R¹ is a hydrophobic moiety, R² is a spacer group, and R³ is a coupling moiety. In some embodiments, the sensor further includes a source region and a drain region, wherein the channel is configured to electrically couple the source region and drain region (as in FIG. 1). As noted above, in some embodiments, the method includes correlating a current that is passed through the channel 107 with an amount of the analyte in the sample (see, for example, the relationship shown in FIG. 7 between conductance (and thus current and voltage) and binding events (S₁, S₂, S₃, S₄, and S₅).

In some embodiments, applying a voltage to the channel that is effective to obtain a current through the channel includes applying a voltage between the source region and the drain region.

In some embodiments, the analyte to be detected is one or more of nitrogen gas, argon gas, Cl₂, Br₂, a hydrophobic molecule, a molecule including a hydrophobic surface, or a molecule including a hydrophilic surface.

In some embodiments, the method includes applying a first radiation, for example at 450 nm, to photoisomerize the azobenzene compound from a cis isomer to a trans isomer. The first radiation can be applied before the sample contacts the azobenzene compound, at about the same time as the sample contacts the azobenzene compound, or both. In some embodiments, the first radiation has a wavelength of about 450 nm. In some embodiments, the first radiation includes visible light wavelengths. In some embodiments, the first radiation has wavelengths of about 400 nm to about 500 nm, for example, 410 nm, 420 nm, 430 nm, 440 nm, 450 nm, 460 nm, 470 nm, 480 nm, 490 nm, or 500 nm, including any range between any two of the preceding values. In some embodiments, the wavelength to transform from cis to trans is 400 nm to 500 nm.

In some embodiments, the method further includes applying a second amount of radiation to photoisomerize the azobenzene compound from a trans isomer to a cis isomer, wherein the second radiation is applied before the sample contacts the azobenzene compound, at about the same time as the sample contacts the azobenzene compound, or both. In some embodiments, the second radiation has a wavelength of about 350 nm. In some embodiments, the radiation has wavelengths that correspond to UVA wavelengths. In some embodiments, the radiation has wavelengths of about 315 nm to about 400 nm, for example, 320 nm, 330 nm, 340 nm, 350 nm, 360 nm, 370 nm, 380 nm, 390 nmor 400 nm, including any range between any two of the preceding values. In some embodiments, the wavelength to transform from trans to cis is from 320-400 nm. In some embodiments, the wavelength to transform from trans to cis is from 300-450 nm.

In some embodiments, the method further includes heating the azobenzene compound to a temperature effective to detach the analyte from the azobenzene compound after measuring the current (or conductance). The method can also include applying a second radiation to photoisomerize the azobenzene compound from a trans isomer to a cis isomer, wherein the second radiation is applied after heating the azobenzene compound, at about the same time as heating the azobenzene compound, or both.

In some embodiments, the method can further include contacting a second sample (or any number of additional samples) suspected of containing a second analyte with the azobenzene compound. The method can further include applying a second voltage (or any number of additional voltages) to the channel that is effective to obtain a current through the channel while the second sample contacts the azobenzene compound, and measuring a second current (or conductance) through the channel while applying the second voltage. In some embodiments, the method further includes correlating the second current (or conductance) through the channel with an amount of the second analyte in the sample. In some embodiments, the method further includes heating the azobenzene compound at a temperature effective to detach the second analyte from the azobenzene compound, and applying the first radiation effective to photoisomerize the azobenzene compound form a cis isomer to a trans isomer. The first radiation can be applied after heating the azobenzene compound, at about the same time as heating the azobenzene compound, or both.

In some embodiments, the process can be repeated 2, 10, 20, 30, 40, 50, 100 or more times. In some embodiments, bound analyte can be removed by heat, radiation, or the combination of heat and radiation.

In some embodiments, the method further includes heating the azobenzene compound to a temperature effective to detach any attached analyte from the azobenzene compound. This can be done whenever one wishes to reuse a sensor. In some embodiments, the method can further include applying a first amount of radiation that is effective to photoisomerize the azobenzene compound form a cis isomer to a trans isomer (for example visible light). The first radiation is applied after heating the azobenzene compound, at about the same time as heating the azobenzene compound, or both. The method can further include contacting a second sample suspected of containing a second analyte with the azobenzene compound. The method can further include applying a second voltage to the channel that is effective to obtain a current through the channel while the second sample contacts the azobenzene compound and measuring a second current through the channel while applying the second voltage (to, for example, determine the conductance). In some embodiments, the method further includes correlating the second current (or conductance) through the channel with an amount of the second analyte in the sample. In some embodiments, the process can be repeated with more than two samples, for example, 2, 10, 20, 30, 40, 50, 60, 70, 80, 90, or 100 samples or more, including any range between any two of the preceding values and any range above any one of the preceding values.

In some embodiments, the device and methods provided herein allow for a single sensor to be used to detect hydrophobic molecules or hydrophilic molecules. In some embodiments, the device can be switched by the application of specific wavelengths of light and/or amounts of heat. In some embodiments, this allows for a single sensor to detect both options, thereby saving space on a sensor device.

In some embodiments, a method of making a sensor is provided. In some embodiments, the method can include contacting an azobenzene compound with a surface of a channel. In some embodiments, any of the azobenzene compounds provided herein can be employed. For example, in some embodiments the azobenzene compound is represented by Formula (I) or Formula (II):

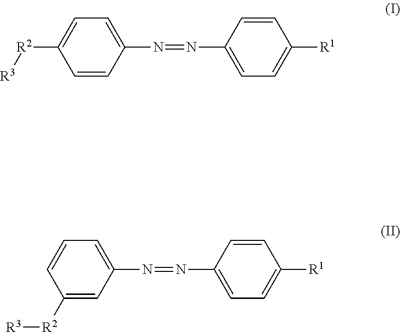

In some embodiments, R¹ is a hydrophobic moiety, R² is a spacer group, and R³ is a coupling moiety (such as a silane coupling moiety).

In some embodiments, any one or more of the components of the device, as provided herein, can be formed and associated with the azobenzene compound. In some embodiments, the method includes forming a source region electrically coupled to the channel and forming a drain region electrically coupled to the channel.

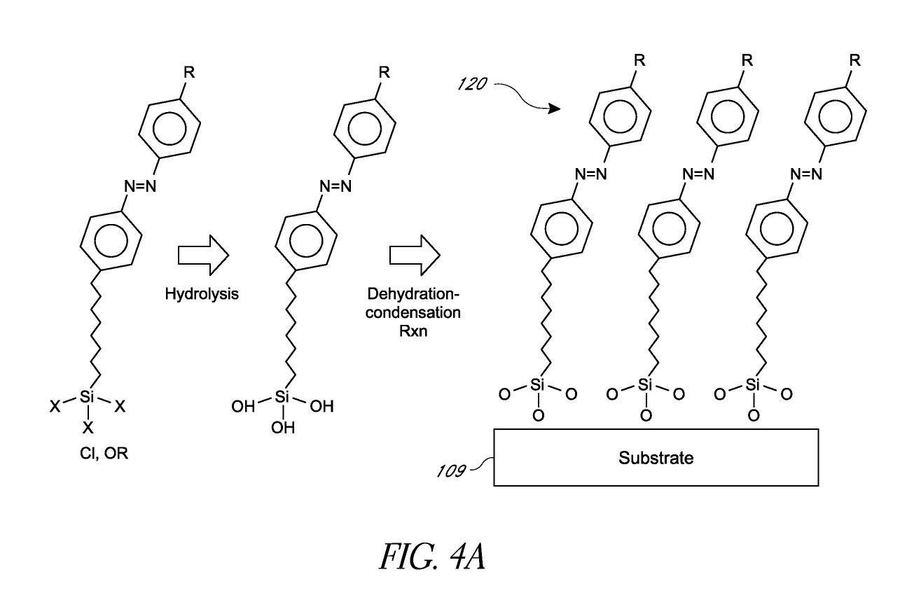

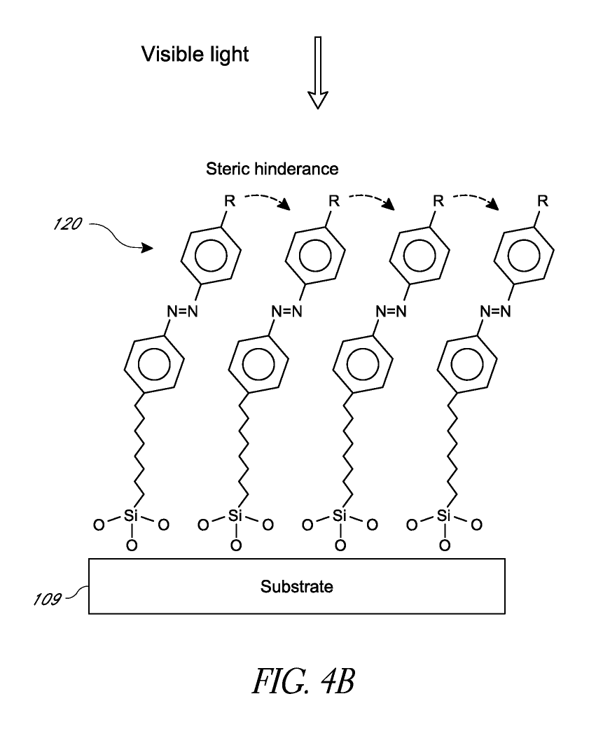

In some embodiments, the application of the azobenzene compound can be done in a manner so as to encourage and/or allow the cis to trans conformational change to happen without (or with less) interference from one another. For example, as shown in FIG. 4A, the addition of the azobenzene molecule 120 to the substrate 109 can be achieved by hydrolysis in some embodiments (followed by a dehydration-condensation reaction) to associate the azobenzene molecules 120 onto the substrate 109. However, in such embodiments, (if performed at certain concentrations and/or conditions) there is the possibility that the sensor could be in a highly packed arrangement of azobenzene molecules (see FIG. 4B), such that the application of visible light may not result in the desired conformational changes, due to steric hindrance.

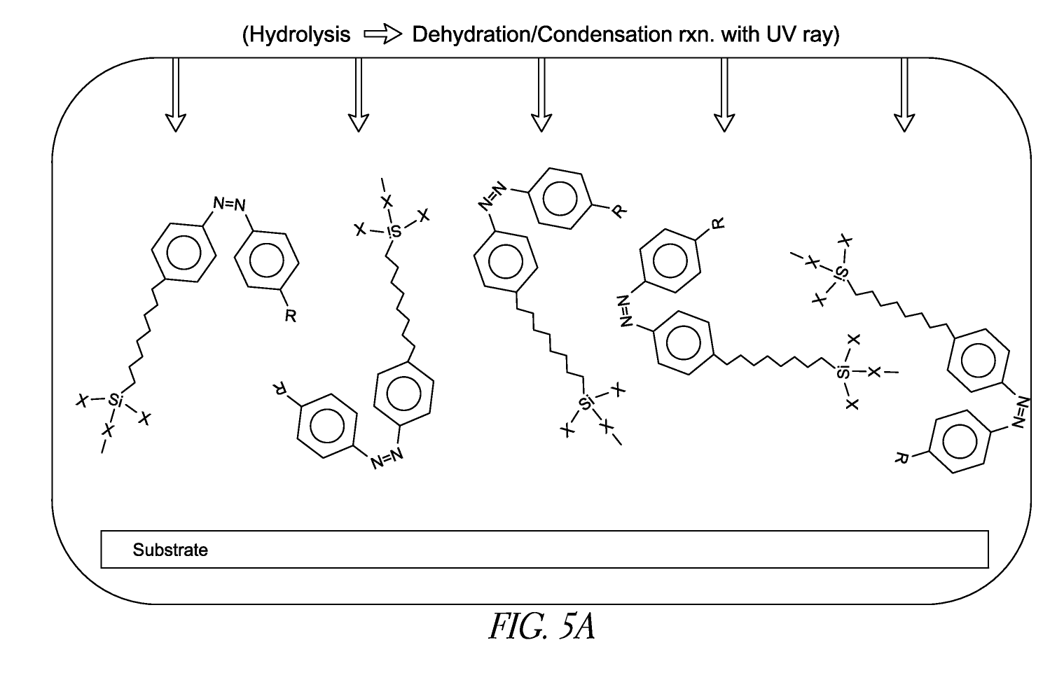

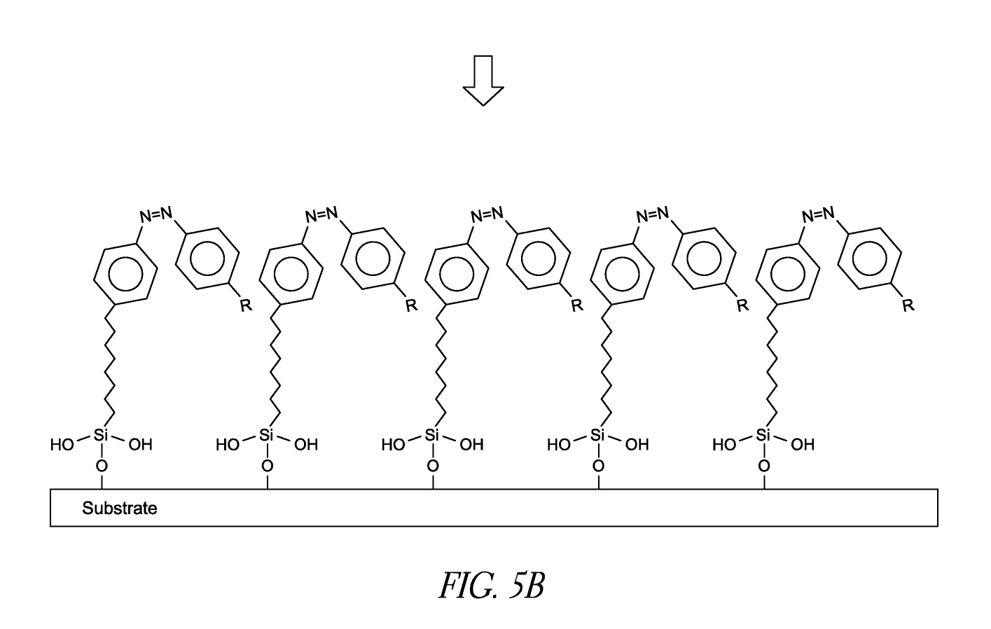

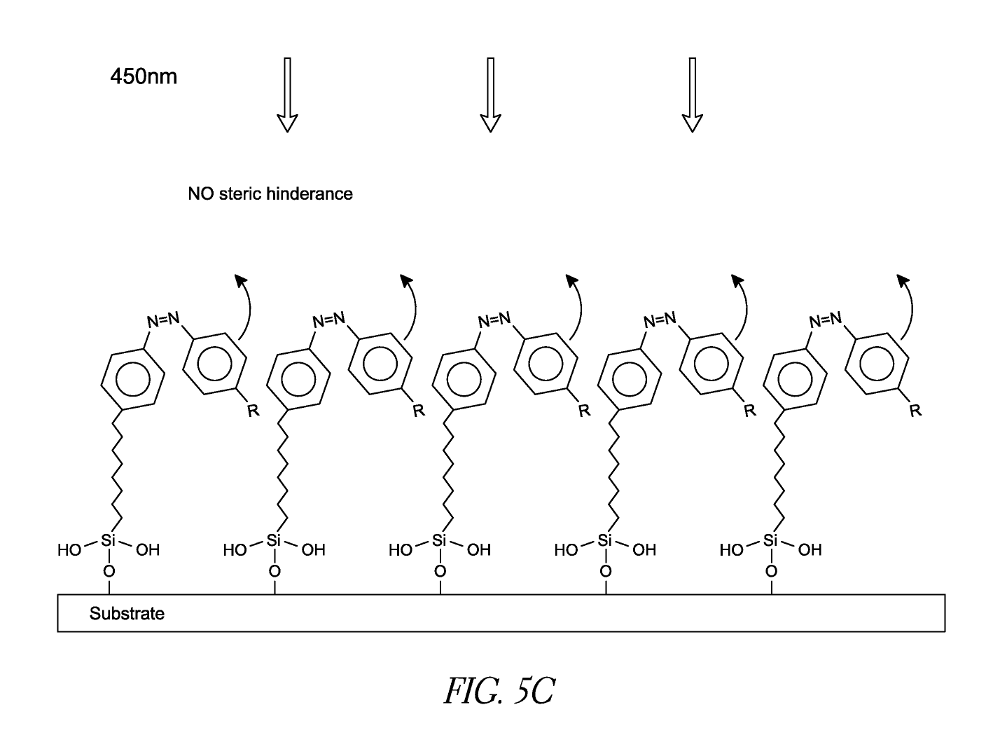

In some embodiments, the azobenzene molecules can be associated with the substrate (for example, following hydrolysis, and during the dehydration/condensation reaction) under, for example, UVA irradiation (see FIG. 5A). As noted herein, in the presence of UVA, the azobenzene molecules are in the cis configuration, resulting in a greater likelihood that there will be more space between the azobenzene molecules (as each molecule can occupy more space on the substrate, thereby reducing the density of the azobenzene molecules that react with the substrate (see FIG. 5B). Following the attachment under UVA irradiation, the substrate and azobenzene molecules that are attached to each other can then be exposed to visible light (for example, 450 nm) to convert the sensor to the trans configuration (see FIG. 5C). Thus, in some embodiments, the method includes applying radiation to the azobenzene compound to photoisomerize the azobenzene compound from a cis isomer to a trans isomer, or from a trans isomer to a cis isomer. The radiation can be applied at about the same time as or just before reacting the azobenzene compound with the surface of the channel. In some embodiments, the radiation that is effective to photoisomerize the azobenzene compound from a trans isomer to a cis isomer has a wavelength of about 350 nm. In some embodiments, the radiation that is effective to photoisomerize the azobenzene compound from a cis isomer to a trans isomer has a wavelength of about 450 nm. In some embodiments, this can be achieved by altering the temperature as well (so that addition of the azobenzene compound occurs in the cis configuration, while reversion to the trans configuration occurs after attachment).

In some embodiments, the azobenzene compound can be associated with a surface of the substrate (for example the channel) as a self-assembled monolayer (SAM). Thus, the concentration of the azobenzene compound can be adequate to allow for self-assembly onto the surface. In some embodiments, this self-assembly is achieved and/or stabilized via Van der Waals interactions between, for example, the spacer moieties 103. In some embodiments, the self-assembly occurs via the coupling moiety 125, as it couples to the channel 107.

In some embodiments, any of the various components for the azobenzene moieties can be employed. For example, in some embodiments, the hydrophobic moiety is an alkyl, haloalkyl, or a halogen. In some embodiments, the spacer group is a C₁₋₂₀-alkylene. In some embodiments, the azobenzene compound is represented by Formula (I) and the spacer group is a C₁₋₂₀-alkylene having an even number of carbon atoms. In some embodiments, the azobenzene compound is represented by Formula (II) and the spacer group is a C₁₋₂₀-alkylene having an odd number of carbon atoms. In some embodiments, the silane coupling moiety is —SiX₃, wherein X is a hydrolyzable group. In some embodiments, the hydrolyzable group is C₁₋₆ alkoxy, acyloxy, bromine, iodine, fluorine, amine, or chlorine. In some embodiments, one can immobilize on silicone, titanium, and/or an aluminum substrate via an oxide film.

In some embodiments, contacting the azobenzene compound with the surface of the channel includes contacting an aqueous solution including the azobenzene compound with the channel.

In some embodiments, the channel is configured as part of a nanodot transistor, nanowaire transistor, carbon nanotube transistor or a FinFET transistor. Thus, in some embodiments, the azobenzene compound is attached to, and/or made part of, a nanodot transistor, nanowaire transistor, carbon nanotube transistor or a FinFET transistor.

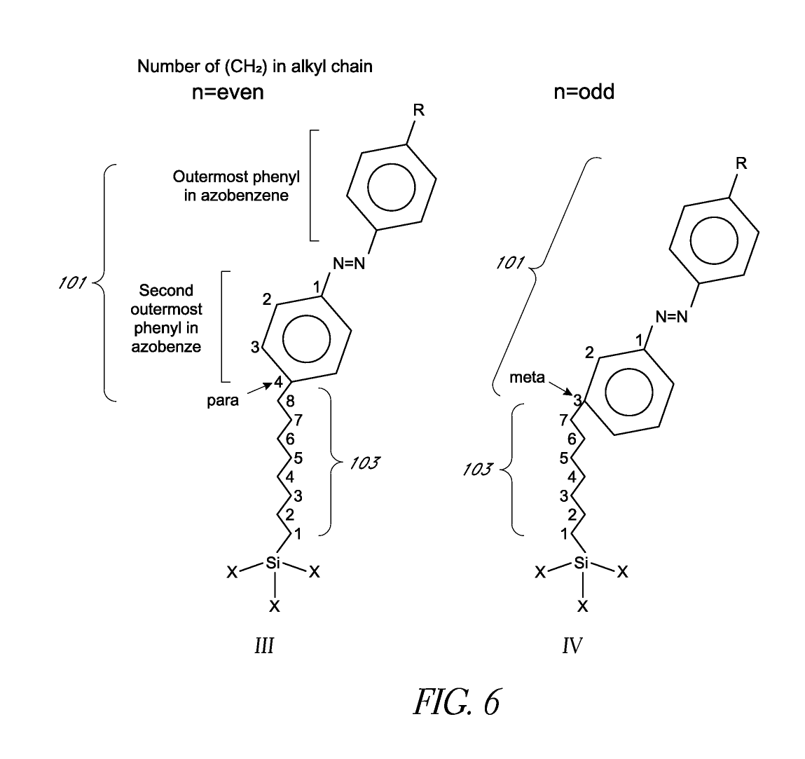

In some embodiments, the azobenzene compound can have the spacer 103 attached to the para position of the azobenzene moiety 101 (as shown in Formula III in FIG. 6). In such an arrangement, the spacer can have an even number of CH₂ in its alkyl chain. In some embodiments, the azobenzene compound can have the spacer 103 attached to the meta position of the azobenzene moiety 101 (as shown in Formula IV in FIG. 6). In such an arrangement, the spacer can have an odd number of CH₂ in its alkyl chain.

In some embodiments, any one or more of the azobenzene molecules can be part of a kit. In some embodiments, the kit includes a sensor configured to detect an analyte. The sensor can include a source region, a drain region, a channel configured to electrically couple the source region and the drain region, and a self-assembled monolayer disposed on the channel. The self-assembled monolayer can include an azobenzene compound coupled to the self-assembled monolayer. In some embodiments, the azobenzene compound is represented by Formula (I) or Formula (II):

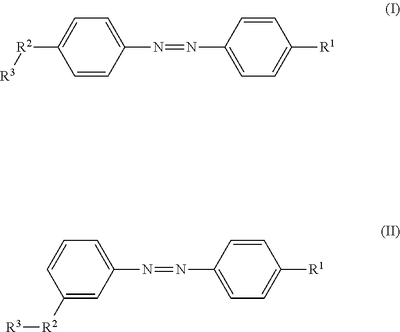

wherein R¹ is a hydrophobic moiety, R² is a spacer group, and R³ is a coupling moiety.

In some embodiments, the kit further includes one or more positive control samples including the analyte. In some embodiments, the kit further includes a negative control sample. The negative control sample contains no more than trace amounts of the analyte. In some embodiments, the negative control sample does not contain the analyte. In some embodiments, the kit further includes instructions for performing a method of sensing the analyte in a sample. In some embodiments, the method includes contacting the sample suspected of containing the analyte with the self-assembled monolayer, applying a voltage between the source region and the drain region while the sample contacts the self-assembled monolayer, and measuring a current (to obtain the conductance) between the source region and the drain region while applying the voltage. In some embodiments, the method further includes correlating the current between the source region and the drain region with an amount of the analyte in the sample (for example, as shown in FIG. 7). As will be appreciated from FIG. 7, one can measure any of the variables provided in the graph to obtain the information for binding, thus, measuring current, voltage, or conductance can be used interchangeably herein, as appropriate.

In some embodiments, a sensor chip is provided. The chip can include a flow cell path configured to permit a fluid (such as a liquid or a gas) to flow across a surface, a source region, a drain region, and a channel in electrical communication with the source region and the drain region, wherein the channel is positioned within the flow cell path. In some embodiments, the chip can further include a plurality of azobenzene compounds that are covalently attached along a length of the channel. In some embodiments, the azobenzene compounds are represented by Formula (I) or Formula (II):

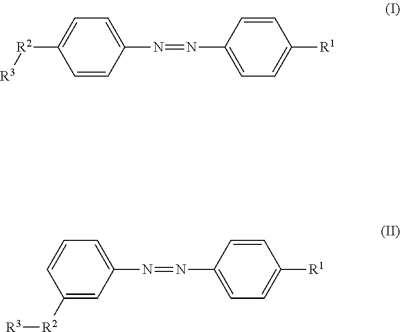

In some embodiments, R is a hydrophobic moiety, R² is a spacer group, and R³ is a coupling moiety.

### EXAMPLES

### Example 1

### Production of a Dynamic Chemical Sensor

The azobenzene compound of Formula IV:

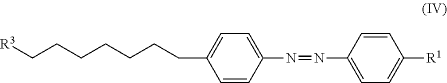

wherein R¹ is a tert-butyl and R³ is a silane coupling moiety, is provided in solution.

The compound is hydrolyzed and then covalently attached to a surface of a channel (as shown in FIG. 1) via a dehydration-condensation reaction. However, prior to allowing the dehydration-condensation reaction to occur, the solution is exposed to UVA radiation at 350 nm to transition the compound to its cis form prior to and during the dehydration-condensation reaction. Once the dehydration-condensation reaction is effectively completed, the resulting sensor includes channels that are covalently attached to the azobenzene compound at a density that is such that the azobenzene compound can generally transition between the cis form to the trans form without excessive steric interference.

### Example 2

### Use of a Dynamic Chemical Sensor

The dynamic sensor from Example 1 is provided. The sensor is first irradiated with visible light having a wavelength of 450 nm (without any meaningful amount of UVA radiation). The sensor is continuously irradiated with a low level of 450 nm radiation, (to keep the molecules biased to the trans configuration) while a sample containing an analyte to be detected is flowed across the surface of the sensor, allowing the sample to contact the azobenzene compound. While this occurs, a voltage is supplied across the channel, and any changes in current (and thus conductance) are observed. Changes in conductance will indicate binding to the sensor.

The irradiation at 450 nm is then halted, any bound analyte is washed away under heat, and the sensor is irradiated at 350 nm so as to transition the azobenzene compounds to a cis configuration. The same sample is then flowed a second time over the surface of the sensor having the cis configuration (which is biased to a hydrophilic surface). As before, a voltage is supplied across the channel, and any changes in current (and thus conductance) are observed. Changes in conductance will indicate a binding to the sensor. One then compares the degree of binding of the sensor in the trans arrangement to the degree of binding in the cis arrangement to determine the presence or absence of an analyte that is hydrophobic or hydrophilic.

### Example 3

### Standards for Dynamic Chemical Sensors

The sensor from Example 1 is supplied and biased, via exposure to 450 nm radiation, to a trans configuration for the azobenzene compound. Eight samples are prepared. The first sample is a water blank. The second sample is an oil blank. The third through fifth samples are a series of saline solutions that include Cl₂ at 1, 10 and 100 mM concentrations. The sixth through eighth samples are saline solutions that include a small, hydrophobic, peptide, at 1, 10, and 100 nM concentrations.

Each of the samples is run twice over the sensor surface, once when the sensor is exposed to 450 nm (and thus the azobenzene is in the trans configuration, providing a hydrophobic surface) and once when the sensor is exposed to 350 nm (and thus the azobenzene is in the cis configuration, providing a hydrophilic environment). Between each run, the sensor is heated to remove any bound analyte. While each sample is being run, changes in conductance (as outlined in Example 2) are measured to determine binding of each sample under either cis or trans arrangements. The results for each sample are recorded and used as standards for comparison against sample that include unknown, or unknown amounts, of analytes. A subsequent run of a sample that provides a similar set of response curves (across both the cis and trans arrangements) will indicate that the sample is consistent with the corresponding standard.

### Example 4

### Use of a Dynamic Chemical Sensor for a Gas

A sensor including the azobenzene compound of Formula I attached to a transistor is provided. The sensor surface is exposed to visible light to ensure that substantially all of the azobenzene compounds are in trans configuration. The electrical characteristics (IV curves) of the transistor are evaluated before use and stored in a memory as initial data. A gas sample is applied to the sensor, and any hydrophobic analytes are attracted to the azobenzene compounds. During the application of the gas sample, electrical characterization of the transistor can be evaluated to obtain the real-time electrical properties of the transistor. The evaluated data is compared with the initial data.

The sensor is then heated by an embedded heater to detach the attracted molecules. The sensor is then exposed to light having a wavelength of 350 nm by using a broad spectrum light source and an optical filter to select this wavelength. This switches the configuration of the azobenzene compounds from the trans to the cis configuration.

The electrical characterization of the chemical probes in cis configuration can be evaluated to obtain a baseline reading for the cis configuration. The gas sample is then run over the sensor again, and hydrophilic molecules (if any) are attracted to the N═N double bonds. During the gas installation, electrical characterization of the transistor in the cis configuration can be evaluated in the same manner as noted above. The evaluated data for the cis configuration is compared with the baseline data for the cis configuration.

The data generated from the above method can be used to characterize a single analyte within a sample by comparing the two results from the cis and the trans sensors so as to help identify a molecule that is either hydrophobic or hydrophilic. Alternatively, the data generated can be used to characterize the presence or absence of both hydrophobic analytes in a sample and hydrophilic analytes in a sample, using the same sensor.

The sensor can finally be heated by the embedded heater to detach the attracted molecules and to switch the configuration from cis to trans configuration.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and so on.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, and so on.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and so on.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and so on.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, and so on. As a non-limiting example, each range discussed herein can be readily broken down into a lower third, middle third and upper third, and so on. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A sensor, comprising:
at least one channel; and
at least one azobenzene compound coupled to the at least one channel, wherein the at least one azobenzene compound is represented by Formula (I) or Formula (II): 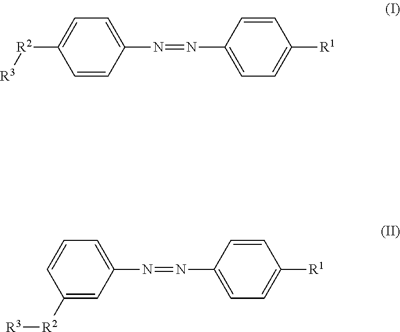
wherein R¹ is a hydrophobic moiety, R² is a spacer group, and R³ is a coupling moiety having a formula —SiX₃, and wherein X is a hydrolyzable group.

2. The sensor of claim 1, further comprising a source region and a drain region, wherein the at least one channel is configured to electrically couple the source region and the drain region.

3. The sensor of claim 1, further comprising a self-assembled monolayer on the at least one channel, wherein the self-assembled monolayer comprises the at least one azobenzene compound.

4. (canceled)

5. (canceled)

6. The sensor of claim 1, wherein the hydrophobic moiety is an alkyl, haloalkyl, a fatty acid, or a halogen.

7. The sensor of claim 1, wherein the spacer group is a C₁₋₃₀-alkylene.

8. The sensor of claim 1, wherein the at least one azobenzene compound is represented by Formula (I) and the spacer group is a C₁₋₂₀-alkylene having an even number of carbon atoms.

9. The sensor of claim 1, wherein the at least one azobenzene compound is represented by Formula (II) and the spacer group is a C₁₋₂₀-alkylene having an odd number of carbon atoms.

10. (canceled)

11. The sensor of claim 1, wherein the hydrolyzable group is hydrogen, C₁₋₆-alkoxy, acyloxy, amine, iodine, fluorine, bromine, or chlorine.

12. The sensor of claim 1, wherein the at least one azobenzene compound of the Formula (II) is further represented by a compound of Formula (III): 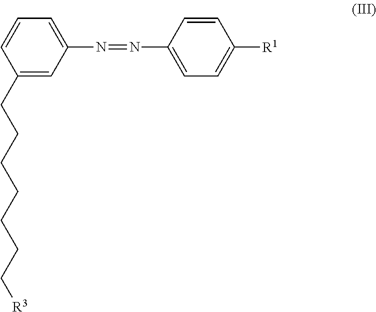
wherein R¹ is methyl, tert-butyl, trifluoromethyl, fluorine, chlorine, bromine, or iodide.

13. The sensor of claim 1, wherein the at least one azobenzene compound of the Formula (I) is further represented by a compound of Formula (IV): 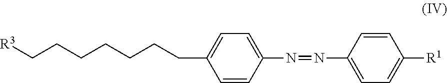
wherein R¹ is a hydrophobic molecule, a protein, a nucleic acid, methyl, tert-butyl, trifluoromethyl, fluorine, chlorine, bromine, or iodide.

14. The sensor of claim 1, wherein the at least one channel is configured as part of a nanodot transistor, nanowaire transistor, carbon nanotube transistor, or a FinFET transistor.

15. (canceled)

16. The sensor of claim 1, further comprising an insulation layer, wherein the at least one channel is disposed on the insulation layer.

17. The sensor of claim 16, further comprising a substrate, wherein the insulation layer is disposed between the substrate and the at least one channel.

18. The sensor of claim 1, further comprising one of:
an optical filter configured to selectively transmit radiation having a wavelength effective to photoisomerize the at least one azobenzene compound;
a light source configured to emit radiation effective to photoisomerize the at least one azobenzene compound from a cis isomer to a trans isomer, or from a trans isomer to a cis isomer; or
a heat source configured to emit heat effective to photoisomerize the at least one azobenzene compound.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. A method to sense an analyte, the method comprising:
contacting a sample suspected to contain an analyte with a sensor including a channel having an azobenzene compound coupled thereto, the azobenzene compound having Formula (I) or Formula (II): 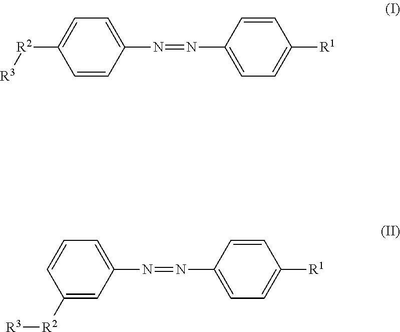
wherein R¹ is a hydrophobic moiety, R² is a spacer group, and R³ is a coupling moiety and is a silane containing a hydrolyzable group;
applying a first voltage to the channel that is effective to obtain a first current through the channel; and
measuring the first current through the channel while applying the first voltage.

38. The method of claim 37, wherein the sample includes a first sample associated with the first voltage and the first current, the method further comprising:
contacting a second sample with the azobenzene compound, wherein the second sample is substantially free of the analyte;
applying a second voltage to the channel that is effective to obtain a second current through the channel; and
measuring the second current through the channel while applying the second voltage.

39. The method of claim 38, further comprising:
contacting a third sample with the azobenzene compound, wherein the third sample contains an amount of the analyte;
applying a third voltage to the channel that is effective to obtain a third current through the channel; and
measuring the third current through the channel while applying the third voltage.

40. (canceled)

41. The method of claim 37, further comprising correlating the current through the channel with an amount of the analyte in the sample.

42. (canceled)

43. (canceled)

44. The method of claim 37, wherein the analyte is one or more of nitrogen gas, argon gas, Cl₂, Br₂, a molecule comprising a hydrophobic surface, or a molecule comprising a hydrophilic surface.

45. The method of claim 37, further comprising one of:
applying a first radiation to photoisomerize the azobenzene compound from a cis isomer to a trans isomer, wherein the first radiation is applied before the sample contacts the azobenzene compound, at about a same time as the sample contacts the azobenzene compound, or both; or
applying a second radiation to photoisomerize the azobenzene compound from a trans isomer to a cis isomer, wherein the second radiation is applied before the sample contacts the azobenzene compound, at about the same time as the sample contacts the azobenzene compound, or both.

46. The method of claim 45, wherein the first radiation has a wavelength of about 450 nm and the second radiation has a wavelength of about 350 nm.

47. (canceled)

48. (canceled)

49. (canceled)

50. (canceled)

51. The method of claim 37, wherein the analyte includes a first analyte, the sample includes a first sample, the method further comprising:
heating the azobenzene compound to a temperature effective to detach the analyte from the azobenzene compound after measuring the current;
photoisomerizing the azobenzene compound by one of:
applying a first radiation effective to photoisomerize the azobenzene compound form a cis isomer to a trans isomer, wherein the first radiation is applied after heating the azobenzene compound, at about a same time as heating the azobenzene compound, or both; or
applying a second radiation to photoisomerize the azobenzene compound from a trans isomer to a cis isomer, wherein the second radiation is applied after heating the azobenzene compound, at about the same time as heating the azobenzene compound, or both;
contacting a second sample suspected to contain a second analyte with the azobenzene compound;
applying a second voltage to the channel that is effective to obtain a second current through the channel while the second sample contacts the azobenzene compound; and
measuring the second current through the channel while applying the second voltage.

52. The method of claim 51, further comprising correlating the second current through the channel with an amount of the second analyte in the second sample.

53. (canceled)

54. (canceled)

55. (canceled)

56. A kit, comprising:
a sensor configured to detect an analyte, the sensor comprising:
a source region;
a drain region;
a channel configured to electrically couple the source region and the drain region;
a self-assembled monolayer disposed on the channel, the self-assembled monolayer comprising an azobenzene compound coupled to the self-assembled monolayer, wherein the azobenzene compound is represented by Formula (I) or Formula (II): 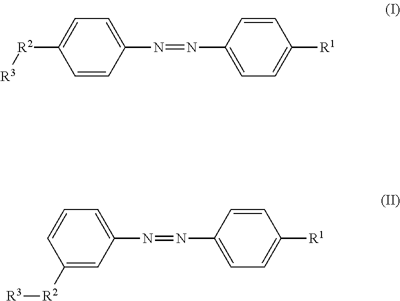
wherein R¹ is a hydrophobic moiety, R² is a spacer group, and R³ is a silane coupling moiety having one or more hydrolyzable groups; and
one of one or more positive control samples including the analyte or a negative control sample, wherein the negative control sample includes no more than trace amounts of the analyte.

57. (canceled)

58. (canceled)

59. (canceled)

60. The kit of claim 56, further comprising instructions to perform a method to sense the analyte in a sample suspected to contain the analyte, the method comprising:
contacting the sample suspected of containing the analyte with the self-assembled monolayer;
applying a voltage between the source region and the drain region while the sample contacts the self-assembled monolayer; and
measuring a current between the source region and the drain region while applying the voltage.

61. (canceled)

62. (canceled)
